(19) United States
(12) Patent Application Publication
(10) Pub. No.: US 2008/0121073 A1
(43) Pub. Date: May 29, 2008

(54) Socket wrench for lug nuts

(76) Inventor: Nathan Williams, Rochester, WA (US)

Correspondence Address: BARNARD INTELLECTUAL PROPERTY LAW, INC., P.O. BOX 58888, SEATTLE, WA, 98138-1888, US

(21) Appl. No.: 11/897,030

(22) Filed: Aug. 28, 2007

Related U.S. Application Data
(63) Continuation-in-part of application No. 11/605,089, filed on Nov. 27, 2006, now abandoned.

(51) Int. Cl. B25B 13/06

(52) U.S. Cl. 81/121.1

(57) ABSTRACT

A socket wrench (10) has tubular sections (20, 24) at its opposite ends separated by a center wall (26) that includes a non-circular socket (28) for receiving a complementary shaped end portion (30) of a turning tool (32). The tool (32) is inserted endwise through one end of the tool (10) and its end (30) is inserted into the socket (28) lug-receiving recesses (38) formed in the opposite end of the wrench (10) are moved to engage lugs (18) on a lug nut (12, 14). Each end of the socket wrench (10) is constructed to engage a different size lug nut (12, 14). At its longitudinal center, the socket wrench (20) is provided with wrench flats (46) for receiving the jaws (50) for an open-ended wrench (48). The end portions (22, 24) are preferably provided with knurling, serrations, or some other high friction surface that can be easily held so that a user can turn the socket wrench (10) by hand. A center section between the tubular sections (20, 24) includes at least one radially extending opening (THI) sized to receive an end portion of a turning tool (TI).

### RELATED APPLICATION

This application is a continuation-in-part of my co-pending application Ser. No. 11/605,089, filed Nov. 27, 2006, and entitled Socket Wrench For Lug Nuts.

### TECHNICAL FIELD

This invention relates to the provision of a new and improved socket wrench. More particularly, it relates to the provision of a socket wrench having a socket at each end for engaging two sizes of lug nut, and to a construction of the socket wrench which allows it to be rotated by a handle that is inserted endwise into the socket wrench, by an open ended wrench orientated crosswise to the socket wrench, and by hand.

### BACKGROUND OF THE INVENTION

Herein, a “lug nut” is a nut having a ring-shaped body surrounding an internally threaded opening and having a plurality of circumferentially spaced apart lugs that extend radially outwardly from the body. Examples of this type of nut is disclosed by U.S. Pat. No. 2,909,090, granted Oct. 20, 1959, to Rollin A. Moore, and by U.S. Pat. No. 6,826,984, granted Sep. 7, 2004, to Keith K. Poppen.

U.S. Pat. No. 3,086,414, granted Apr. 23, 1963, to Guy Nardi discloses a socket wrench having a socket at one end only which is adapted to receive square nuts, hexagonal nuts and wing nuts.

U.S. Pat. No. 5,048,379, granted Sep. 17, 1991 discloses a double-ended socket wrench having an external drive collar at its center and an internal drive well between its ends. It is an object of the present invention to provide an improved double-ended socket wrench having internal and external drive portions and opposite end sections with substantially equal outside diameters which provide outer surfaces that are positioned outwardly from the outer wrench surfaces at the center of the socket wrench.

U.S. Pat. No. 5,697,268, granted Dec. 16, 1997, to Keith A. Makovsky and Joseph J. Kavanagy discloses a single-ended socket wrench for driving a wing nut or the like.

U.S. Pat. No. 5,862,725, granted Jan. 26, 1999, to Joel Anegus discloses a double-ended socket wrench for antenna nuts. It has two sets of exterior wrench flats at its center which project radially outwardly beyond the end sections of the wrench which are generally tubular. The two sets of external wrench flats are axially separated by a split ring set into slots.

U.S. Pat. No. 6,058,813, granted May 9, 2000, to Paul Bryant and Barry Douglas Luthanen discloses a single-ended socket wrench that is pivotally connected to one end of a handle.

U.S. Pat. No. 6,729,208, granted May 4, 2004, to Joe Chrzanowski discloses a double-ended socket wrench having a different size socket at each end and an internal drive pin-receiving socket.

U.S. Pat. No. 6,779,424, granted Aug. 24, 2004, to Fred William Schmidt discloses a box wrench for lock nuts such as employed with electrical connectors. The wrench includes an elongated handle having a different size box wrench at each of its ends.

Some lug nuts have six lugs and others have eight lugs. There is a need for a wrench that can be used for turning both a six lug nut and an eight lug nut. There is also a need for a socket wrench for a lock nut that can be rotated by more than one tool, and also can be rotated by hand. The primary object of the invention is to fill those needs.

### BRIEF SUMMARY OF THE INVENTION

A socket wrench constructed according to the present invention includes an elongated body having first and second tubular end sections and a center wall between the end sections. The center wall preferably includes a non-circular socket for receiving the non-circular end portion of a tool that is rotatable for rotating the wrench. The first tubular end section includes a circular outer end and a plurality of lug-receiving recesses formed in said outer end. The second tubular end section includes a circular outer edge and a plurality of lug-receiving recesses formed in said outer end. The center section has an outside portion that includes wrench flats on it spaced circumferentially around the wrench. The wrench flats are adapted to be grasped by an open-ended wrench, so that the open-ended wrench can be used as a second way of rotating the socket wrench.

Preferably, the circular outer end of the first tubular end section has a first number of lug-receiving recesses formed in it and the circular end of the second tubular end section has a different number of lug-receiving recesses formed in it. One of the tubular end sections may include eight lug-receiving recesses and the other may include six lug-receiving recesses.

In preferred form, the end sections of the wrench body are provided with knurling or some other high friction surface that will allow the body to be grasped and turned by hand.

It is a feature of the invention to provide a double-ended socket wrench with a central portion which includes one or more radially extending openings for receiving the end of a turning bar. These openings may be combined with a wrench having external wrench flats at the longitudinal center of the wrench and/or a turning bar receiving internal socket, or both.

Other objects, advantages and features of the invention will become apparent from the description of the illustrated embodiment that is set forth below, from the drawings, from the claims and from the principles that are embodied in the specific structures that are illustrated and described.

### BRIEF DESCRIPTION OF THE SEVERAL VIEWS OF THE DRAWINGS

Like reference numerals are used to designated like parts throughout the several views of the drawing, and:

FIG. 1 is an exploded pictorial view of a socket wrench embodying the invention, showing the lower end portion of a turning tool spaced above the upper end of the socket wrench, showing an eight-lug lock nut spaced below the lower end of the socket wrench, and showing an end portion of an open-ended wrench, positioned radially outwardly from wrench flats provided at the center of the socket wrench, with the jaws of the wrench substantially aligned with opposing wrench flats on opposite sides of the socket wrench;

FIG. 2 is a plan view of the lug nut shown in FIG. 1;

FIG. 3 is a plan view of another lug nut having six lugs on its periphery;

FIG. 4 is a side elevational view of the socket wrench;

FIG. 5 is a longitudinal sectional view of the socket wrench, showing the lower end portion of a turning tool positioned in a socket formed in a center wall;

FIG. 6 is a top plan view of a socket wrench, looking down towards the end of the wrench that is sized and shaped to engage a lug nut having six lugs;

FIG. 7 is a fragmentary view of the center portion of FIG. 4, showing the jaws of the open-ended wrench engaging opposite end flats on the socket wrench;

FIG. 8 is a sectional view taken substantially along line 8-8 of FIG. 7, including a plan view of the jaw end of the open-ended wrench;

FIG. 9 is a view like FIG. 4 showing a double-ended socket wrench that includes a plurality of radially extending turning bar receiving openings in the central region of the wrench;

FIG. 10 is a view like FIG. 5, but of the wrench shown by FIG. 9; and

FIG. 11 is a sectional view taken substantially along line 11-11 of FIG. 10.

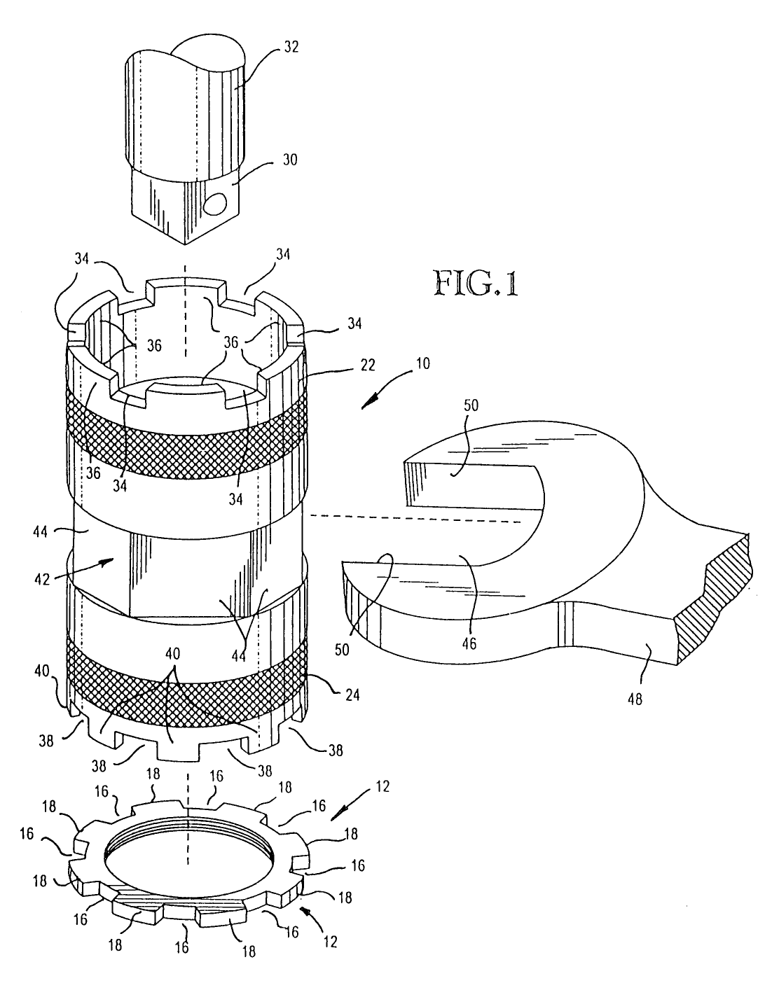

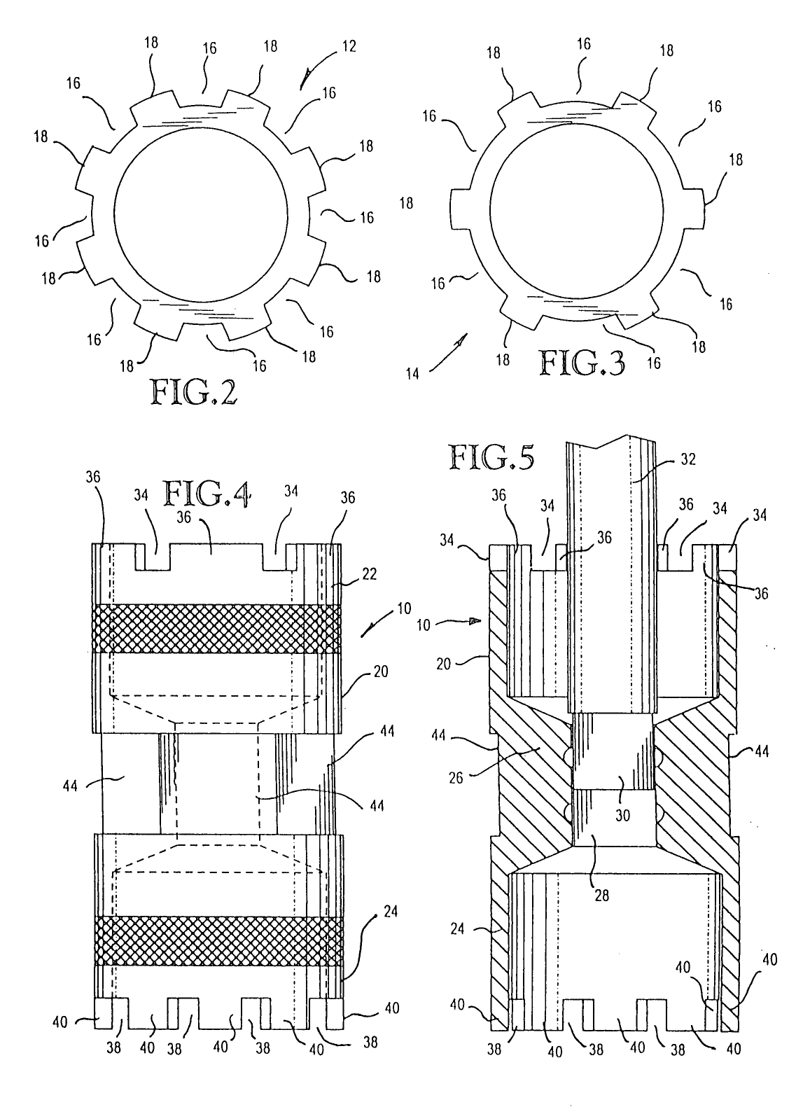

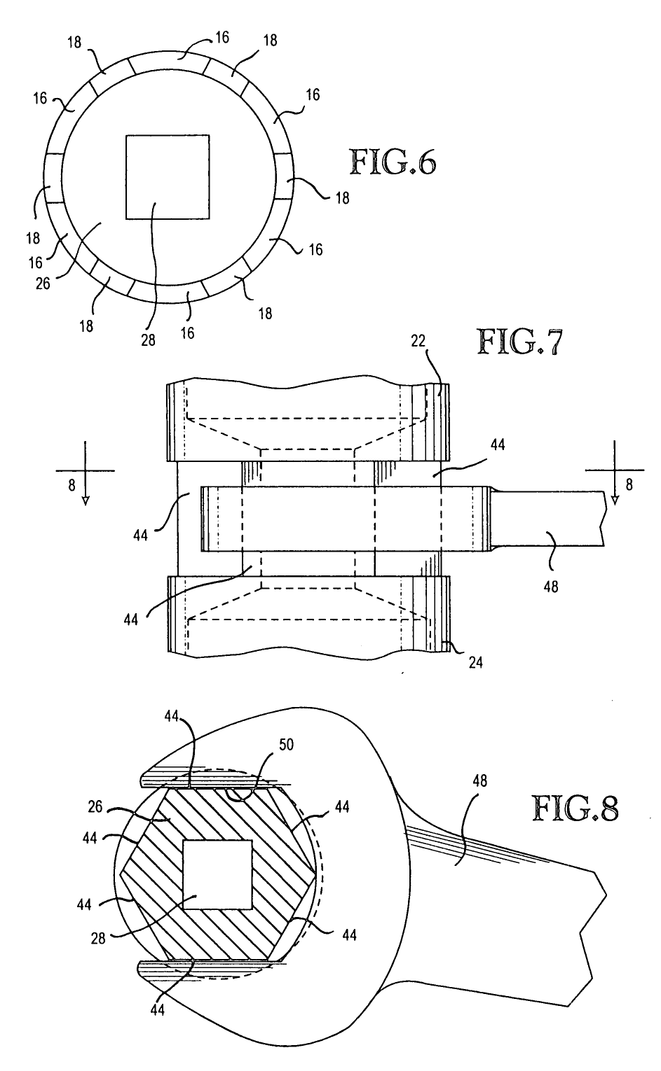

### DETAILED DESCRIPTION OF THE ILLUSTRATED EMBODIMENT

The embodiment shown by the drawing includes a socket wrench 10 for a nut 12, 14 of a type having radially extending openings 16 between radially extending lugs 18. Nut 12 has eight openings and eight lugs. Nut 14 has six openings 16 and six lugs 18.

Wrench 10 has an elongated body 20 having first and second tubular end sections 22, 24 and a center wall 26 between the end sections 22, 24. As will hereinafter be described in greater detail, the center wall 26 may include a non-circular socket 28 that receives a non-circular end portion 30 of a tool 32 provided for rotating the wrench 10.

The first tubular end section 22 includes a circular outer end and a plurality of lug-receiving recesses 34 formed in the outer end. End section 22 has six recesses 34 and six nut engaging portions 36 between the recesses 34. The second tubular end section 24 also has a circular outer edge in which there are formed eight lug receiving recesses 38 separated by eight turning portions 40.

The center section 42 may be formed to include wrench flats 44 which are spaced circumferentially around the wrench 10. In the illustrated embodiment, the wrench 10 is provided with six wrench flats sized to receive wrench jaws at the open end 46 of an open end wrench 48. As best shown by FIG. 8, the wrench 48 has wrench flats 50 which are sized and adapted to engage the wrench flats 46 formed on the outside portion of the center section 42.

FIG. 5 shows the non-circular end portion 30 of a turning tool 32 positioned within the turning tool receiving opening or socket 28 formed in the center walls 26. If room is available for using the turning tool 32, its end portion 30 is inserted into the wrench 10 through the end of the wrench 10 that is not being used. End portion 30 is moved into the socket 28. Then, member 32 is rotated to in turn rotate the tool 10. Tool 32 is inserted into the end portion 22 when the lugs and openings 38, 40 are engaging the lock nut 12. When the wrench 10 is to be used for turning the lock nut 14, the turning tool 32 is inserted into the socket 28 from the opposite end of the tool 10. As shown by FIG. 5, in preferred form, converging surfaces are provided at the opposite ends of the center wall 26 for helping direct the end portion 30 of tool 32 into the socket 28.

There will be times where the nut to be turned is located where there is insufficient room to insert the turning tool 32 endwise into the tool 10. According to the invention, an open end wrench 48 can be used to grasp the wrench flats 44, for turning the tool 10. In the drawings, a fixed jaw open ended wrench 48 is illustrated. However, an adjustable open-end wrench (e.g. a crescent wrench) can be used instead.

The tool 10 may sometimes be rotated by hand. To facilitate hand rotation, a band of knurling, serrations or some other high friction surface is provided on each end section of the tool 10. The high friction surfaces are provided to enable a person to grab the tool 10 and to get a firm grip on it so a person's hand can be used for rotating the tool 10 while minimizing slipperage that might occur between the tool 10 and the hand.

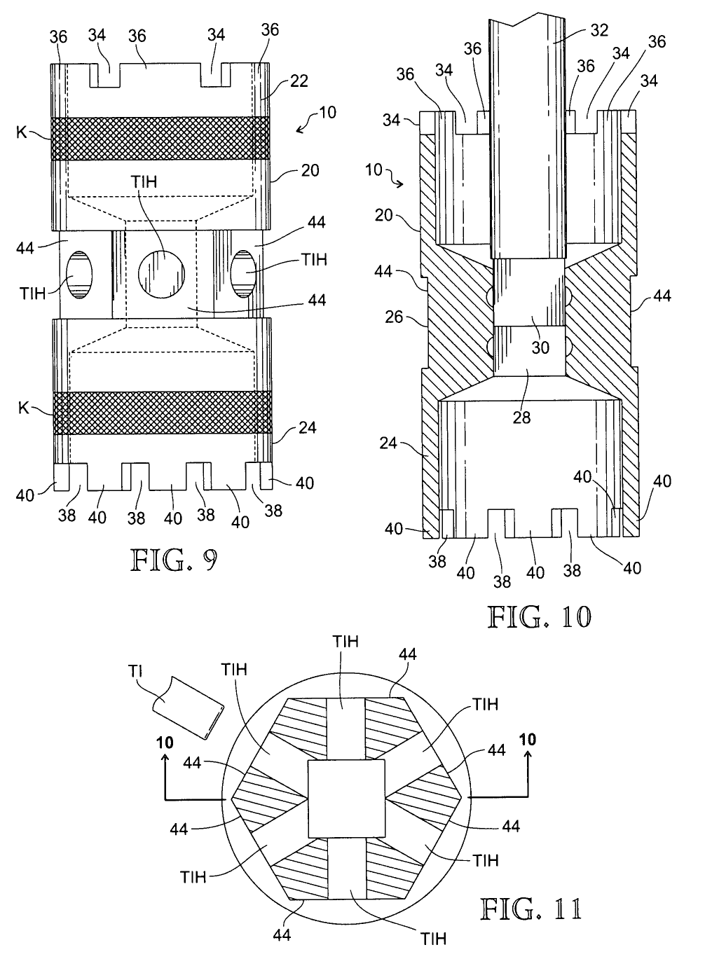

FIGS. 9-11 show another embodiment of the invention. This embodiment includes turning bar receiving openings TIH extending transversely through the central portion of the wrench. Three openings TIH care shown. However, the number can vary from one, to two to three. The side wall of the wrench 10 has a cylindrical outer surface except in the region of the wrench flats 44. The material is cut away to form the wrench flats 44 so that they are positioned radially inwardly of the cylindrical outer boundary of the wrench 10. The center opening 28 for the turning wrench 30 is formed in the central portion of the wrench 10. Substantial material exists between the outer wrench flats 44 and the inner turning bar receiving opening 28 so that the wrench 10 can withstand the turning forces, whether applied on the flats 44, or on the sides of opening 28, or by use of the turning bar TIH.

The opposite ends of the wrench 10 are constructed to engage different size lug nuts. The wrench 10 can be driven four ways. Firstly, a wrench can be used to grip the wrench flats 44 if sufficient room exists of such wrench. Secondly, a turning bar 32 can be inserted through one end or the other into the opening 28, if sufficient room exists to accommodate the turning bar 32. Thirdly, a turning bar TIH can be inserted radially into one of the turning bar holes TIH and used for turning the wrench 10. Fourthly, a user may grab the wrench 10 at one of the bands of knurling, etc. and a person's hand can be used for rotating the tool 10.

The illustrated embodiments are only examples of the present invention and, therefore, are non-limitive. It is to be understood that many changes in the particular structure, materials and features of invention may be made without departing from the spirit and scope of the invention. Therefore, it is my intention that my patent rights not be limited by the particular embodiments that are illustrated and described herein, but rather are to be determined by the following claims, interpreted according to accepted doctrines of patent claim interpretation, including use of the doctrine of equivalents and reversal of parts.

What is claimed is:

1. A socket wrench, comprising:
an elongated body having first and second tubular end sections and a center wall between the end sections, said center wall including a non-circular socket for receiving a complementary non-circular end portion of a tool that is rotatable for rotating the wrench;
said first tubular end section including a circular outer end and a plurality of lug receiving recesses formed in said outer end;
said second tubular end section having a circular outer end and a plurality of lug receiving recesses formed in said outer end;
said center section having an outside portion that includes wrench flats on it spaced circumferentially around the wrench, said wrench flats being adapted to be grasped by an open ended wrench, whereby the open ended wrench can be used as a second way of rotating the lug nut wrench; and
said first and second tubular end sections having a common cylindrical outer boundary, and said wrench flats on the center section be radially inset from the cylindrical outer boundary.

2. The socket wrench of claim 1, wherein the circular outer end of the first tubular end section has a first number of lug receiving recesses formed in it and the circular outer end of the second tubular end section has a different number of lug receiving recesses formed in it.

3. The socket wrench of claim 1, wherein the first tubular end section includes eight lug receiving recesses and the second tubular end section includes six lug receiving recesses.

4. The socket wrench of claim 1, comprising six wrench flats on the outside portion of the center section.

5. The socket wrench of claim 1, wherein the non-circular socket in the center wall is square.

6. A socket wrench of claim 1, wherein said central section having at least one radially extending turning bar receiving opening.

7. A socket wrench, comprising:
an elongated body having first and second tubular end sections and a center wall between the end sections, said center wall including a non-circular socket for receiving a complementary non-circular end portion of a tool that is rotatable for rotating the wrench;
said first tubular end section including a circular outer end and a plurality of lug-receiving recesses formed in said outer end;
said second tubular end section having a circular outer end and a plurality of lug-receiving recesses formed in said outer end;
said end sections each including a grippable friction surface that can be grasped and used for turning the wrench by hand; and
said center wall including at least one radially extending opening for receiving the end of a turning bar.

8. The socket wrench of claim 7, wherein the circular outer end of the first tubular end section has a first number of lug-receiving recesses formed in it and the circular outer end of the second tubular end section has a different number of lug-receiving recesses formed in it.

9. A socket wrench, comprising:
an elongated body having first and second tubular end sections and a center wall between the end sections;
said first tubular end section having a circular outer end and plurality of lug-receiving recesses formed in said outer end;
said second tubular end section having a circular outer end and a plurality of lug-receiving recesses formed in said outer end;
said end sections having a common cylindrical outer boundary, and said wrench flats being inset inwardly from the cylindrical outer boundary; and
said center section having an outside portion that includes wrench flats on it spaced circumferentially around the wrench, said wrench flats being adapted to be grasped by an open-ended wrench, whereby the open-ended wrench can be used for rotating the lug nut wrench.

10. The socket wrench of claim 9, wherein the first and second tubular end sections each includes an external friction surface that can be grasped by a person's hand to facilitate rotation of the socket wrench by hand.

11. The socket wrench of claim 9, wherein the circular outer end of the first tubular end section has a first number of lug-receiving recesses formed in it and the circular outer end of the second tubular end section has a different number of lug-receiving recesses formed in it.

12. The socket wrench of claim 8, wherein the center section includes at least one radially extending turning bar receiving opening.
